(19) United States
(12) Patent Application Publication
(10) Pub. No.: US 2003/0210273 A1
(43) Pub. Date: Nov. 13, 2003

(54) Display image control information creation unit, imatge display method, and image display unit

(75) Inventor: Masashi Yonemura, Tokyo (JP)

Correspondence Address: ARMSTRONG,WESTERMAN & HATTORI, LLP, WO, 1725 K STREET, NW, SUITE 1000, WASHINGTON, DC, 20006, US

(73) Assignee: RICE VILLAGE L.L.C., Tokyo (JP)

(21) Appl. No.: 10/453,498

(22) Filed: Jun. 4, 2003

Related U.S. Application Data
(63) Continuation of application No. PCT/JP01/10393, filed on Nov. 28, 2001.

(30) Foreign Application Priority Data
Dec. 4, 2000 (JP) 2000-368710
May 21, 2001 (WO) PCT/JP01/04227

(51) Int. Cl. G09G 5/00

(52) U.S. Cl. 345/776

(57) ABSTRACT

An creator of a page image inputs display-image specifications including specifications of display information containing positions, shapes, and display order of node-display areas (NW₁, NW₂) in the page image, and selection of at least one layer of the plurality of layers so that when displaying the page image (PIM), the transitions between images intended by the creator occur, for example, as created by the movement of readers' eyes when they read a cartoon on paper, and display-image-control information with respect to the page image is created based on the display-image specifications. Therefore, images with stage effects intended by the creator can be provided for readers by displaying the images according to the display-image-control information created in the above way.

### TECHNICAL FIELD

The present invention relates to a display-image-control-information creation unit, an image-display method, and an image-display unit. More specifically, the invention relates to a display-image-control-information creation unit for creating display-image-control information with respect to a page-image of illustrations drawn in cartoon frames in order of a story progressing, an image-display method for displaying a page-image of illustrations drawn in the frames in order of a story progressing, and an image-display unit for displaying images, using the display-image-control information created by the display-image-control-information creation unit.

### BACKGROUND ART

Comics that are sets of pages, on each page are composed cartoon frames wherein illustrations are drawn in order of a story progressing with or without dialogs, are being published on paper media such as magazines and books. In such a comic on paper media, the illustration in the frame is a static one at a point of time, which is a discrete point of time, in the story. The creator intentionally arranges the cartoon frames in a specific order. By watching the illustration in the frame sequentially, readers can understand the story and follow it. When readers see the cartoon drawn on the paper media, the readers' eyes move in the order intended by the creator. Therefore, the creator employs various techniques to draw the cartoons in an order that the readers can follow the story with a feeling as vivid as if they were present there.

Meanwhile, recently as information technologies have been advancing, comics are being published on storage media such as compact disks that can be read by computers. Furthermore, as communication technologies have been advancing, comics are being published electronically through computer networks.

In the case of a comic published on a medium other than paper, the illustrations thereof are displayed on the screens of display units such as CRT displays and liquid crystal displays, which is connected to processing units of computers. The readers understand a comic story by watching the shift of the image on screen.

In the prior art, when the image of the comic that is published on a medium other than paper is displayed by using the display unit, it is considered that the image can be shifted on screen, page-by-page or frame-by-frame. Under limitations from the screen size and so forth, the page by page shifting of the image has the disadvantage that it cannot give equivalent impressions as vivid as if the reader were present as given by paper media. Furthermore, even though this problem is solved by using a larger screen; the benefit of using a new medium is lost unless equivalent impressions by the paper media are given.

In addition, when a comic image is shifted on a computer, frame-by-frame, the readers can understand the story. However, the image captured by the readers' eyes is quite different from the same image on paper, because readers can follow the frames of a cartoon drawn on a whole page, but they can only follow a single frame shown on a screen. As a result, the creator cannot fully utilize the techniques for cartooning on paper to attract the readers' interest to give the impressions as described above. Therefore, the image display as mentioned above hardly satisfies readers, since the intent of the creator cannot be reflected substantially.

Meanwhile, when the medium for cartoon is switched from paper medium to a new one, the creator optionally adds the new techniques to his cartoon to reflect his intent fully. Even when the new presentation techniques for cartoons are employed, it is required, as a minimum standard, that the image-display effects that the creator adds to his cartoons on paper can be implemented in the new medium.

Accordingly, with new media emerging, new technologies for substantially reflecting the intent of the creator on screen and for providing new image-display effects, as well as the effects on paper, are expected.

Similarly, there is a need for the intent of the creator to be reflected on screen substantially in the presentation of products or plans using an over-head projector (OHP), slide, picture, etc.

The present invention was made in such circumstances, and the first purpose of this invention is to provide an image-display method for performing an image display on screen, wherein a creator can substantially reflect his intent.

Furthermore, the second purpose of this invention is to provide a display-image-control-information creation unit for creating display-image-control information on a screen, wherein the creator can substantially reflect his intent.

Moreover, the third purpose of this invention is to provide an image-display unit for displaying the images reflecting the intent of the creator substantially.

### DISCLOSURE OF INVENTION

According to the first aspect of this invention, there is provided a display-image-control-information creation unit for creating display-image-control information with respect to a page image, comprising: a display-image specifying means for inputting display-image specifications and a display-image-control-information creation means for creating the display-image-control information based on the display-image specifications. The illustrations are drawn in frames arranged on pages in order of a story progressing, by using layered expression technique having a plurality of layers.

The display-image specifying means: specifies the display information containing positions, shapes; displays the order of node-display areas on the page; and chooses at least one layer of the plurality of layers for determining the feature of the shift for an image-display area that shifts sequentially. The display-image-control-information creation means creates the display-image-control information based on the display-image specifications.

When the cartoon is drawn on paper media, the image reflected on the readers' eyes shifts followed by the movement of their eyes. In order to display the page image, the creator of a page image inputs display-image specifications including specifications of information comprising positions and shapes and display order of node-display areas in the page image so as to generate the same shift when the cartoon is drawn on the paper media, via the display-image specification means. Then a display-image-control-information creation means creates the display-image-control information based on the display-image specifications. Accordingly, the display-image-control information can be created, wherein the information is used to perform various kinds of modification including the image-display effects on paper.

In the display-image-control-information creation unit according to the present invention, the plurality of layers may include a figure-display layer and a character-display layer.

Furthermore, in the display-image-control-information creation unit of the present invention, the plurality of layers may comprise at least two layers. One is the layer in which the illustration is drawn according to the progression of the first story, and the other is the layer in which the illustration is drawn according to the progression of the second story different from the first story. The plurality of layers may further comprise at least one layer different from the above-mentioned ones. On the layer, the illustration is drawn according to the progression of the third story, different from the first and second stories for other layers.

Moreover, in the display-image-control-information creation unit of the present invention, the display-image specifications may further comprise between-nodes-display specifications for transition from the node-display area to a next node-display area.

In this case, the between-nodes-display specifications may include at least one specification selected from the group consisting of the time of the transition (or shift), image-blurring, display, fade-in, fade-out, zoom display, image rotation, wipe, the paging effect, ripple display, diffusion display, cross-fading display, mosaic, texture display, and sound effect.

Furthermore, in the display-image-control-information creation unit of the present invention, the display-image specifications may further include, for each of the plurality of layers, node-display option specifications of image display for the node-display area.

In this case, the node-display option specifications may include at least one specification selected from the group consisting of display time, image-blurring, display, fade-in, fade-out, cut-in, cut-out, zoom display, image rotation, wipe, the paging effect, ripple display, diffusion display, cross-fading display, mosaic, texture display, and sound effect.

By using these between-nodes-display specifications and the node-display option specifications, which are impossible to be used as the modification when the paper media is employed, the modification intended by the creator can be added to the page image displayed on screen.

According to the second aspect of the present invention, there is provided an image-display method for displaying a page image according to node-display area information and display-image specifications. The display-image specifications include for choosing and at least one layer among the above-mentioned layers. In the page image, the illustrations are drawn in frames arranged on pages in order of a story progressing, by using layered expression technique having a plurality of layers. Then, the node area information comprises the positions, shapes, and display order of node-display areas specified in the area placed in the page image for determining the feature of the shift for an image-display area that shifts sequentially. The image display is performed, according to the display image specification, by choosing at least one layer among the plurality of the layers described above.

When the creator produces cartoons on the paper media, he determines deliberately the operations, such as the arrangement of the cartoon frames, illustrations, and dialogs, and the techniques for drawing them, considering the image reflected on the readers' eyes. According to this, when the creator employs the layered expression technique, the same shift of the image on paper media, as intended by the creator, is formed reflected on the readers' eyes from the screen. Simultaneously, the images are displayed according to display-image specifications, the creator can display the image with the modification intended by him. The node area-display information specifies positions, shapes, and display order of node-display areas in the page image, and selection of at least one layer of the plurality of layers.

In the image-display method according to this invention, the plurality of layers may include a figure-display layer and a text display layer. In this case, figures and texts (or letters) can be displayed simultaneously in different manners respectively. For example, in displaying the figure and dialogs of a character in a story simultaneously, the figure is displayed in a blurring manner while the texts are displayed in a non-blurring manner. As a result, the figure is given the visual effect due to image-blurring display without making the dialogs hard for readers to read. Likewise, various other effects can be displayed on screen.

In the image-display method according to the present invention, the plurality of layers may be composed of layers, in each of which the illustrations are drawn according to the progression of the respective story, which is different from each other. In this case, the creator can prepare, for each of the developments of the story, after same story branching point, image-display data according to the story-development as a respective layer. As a result, images can be displayed according to a development of the story specified by a key-parameter that is chosen by the reader at the branching point.

According to the third aspect of this invention, there is provided an image-display unit comprising: a storage means for storing display image control information, a display control means for instructing the image display of the display area, and a display means for displaying the image on screen. The storing means stores the page-image data of the illustration drawn in the frame in order of a story progressing and display-image-control information created from the page-image data by a display-image-control-information creation unit of the present invention. The display-control means instructs the display images of display areas of the page image based on the display-image-control information read out of the storage means. The display means displays images according to image-display instructions from the display-control means.

According to this, a display-control unit reads display-image-control information out of the storage means to create image data of a display area from page-image data stored in the storage means, according to the display-image-control information. Then the display-control unit has a display unit display images from the image data. Therefore, images intended by the creator can be displayed.

In the image-display unit of the present invention, the image-display unit may further comprise a display-change-operation means with which to tell the display-control means instructions to change display of the display means according to the display-image-control information.

Wherein, the instructions to change display may include at least one instruction selected from the group consisting of static display, restarting of displays from an interrupted point, preceding node-display area display, next node-display area display, magnified display, and sound volume adjustment.

According to the fourth aspect of the present invention, there is provided a storage medium to be read by a computer, on which the page image data and the display image control information are stored. Wherein, the page image data comprises the illustrations drawn in frames in order of a story progressing. The display-image-control information is created from the page-image data by a display-image-control-information creation unit of the present invention. The image-display unit of the present invention reads the page-image data and display-image-control information out of the medium to display images, according to the display-image-control information, thereby the images intended by the creator can be displayed.

According to the fifth aspect of the present invention, there is provided a computer program to be executed by the computer comprising the steps of reading display-image-control information out of page-image data; and displaying the image data of display areas of the page-image data on a display unit. The page-image data comprises the illustration drawn in the frame in order of a story progressing and the display-image-control information is created from the page-image data by a display-image-control-information creation unit of the present invention. The image of the display area in the page-image data is displayed on the display unit based on the display-image-control information read out. When the computer program is executed, the images intended by the creator can be displayed.

### BRIEF DESCRIPTION OF THE DRAWINGS

FIG. 1 is a block diagram showing the structure of an image-information-delivery system according to an embodiment of this invention;

FIG. 2 is a block diagram showing the structure of an image-information-creation unit in FIG. 1;

FIG. 3 is a block diagram showing the structure of an image-information-delivery unit in FIG. 1;

FIG. 4 is a block diagram showing the structure of an image-display unit in FIG. 1;

FIGS. 5A to 5C are views for explaining an example of page-image data created in a stratified manner;

FIGS. 6A and 6B are views for explaining how to create image information using the image-information-creation unit;

FIGS. 7A to 7C are views for explaining the transitions between images displayed by the image-display unit; and

FIG. 8 is a view for explaining image-display of a plurality of areas.

### BEST MODE FOR CARRYING OUT THE INVENTION

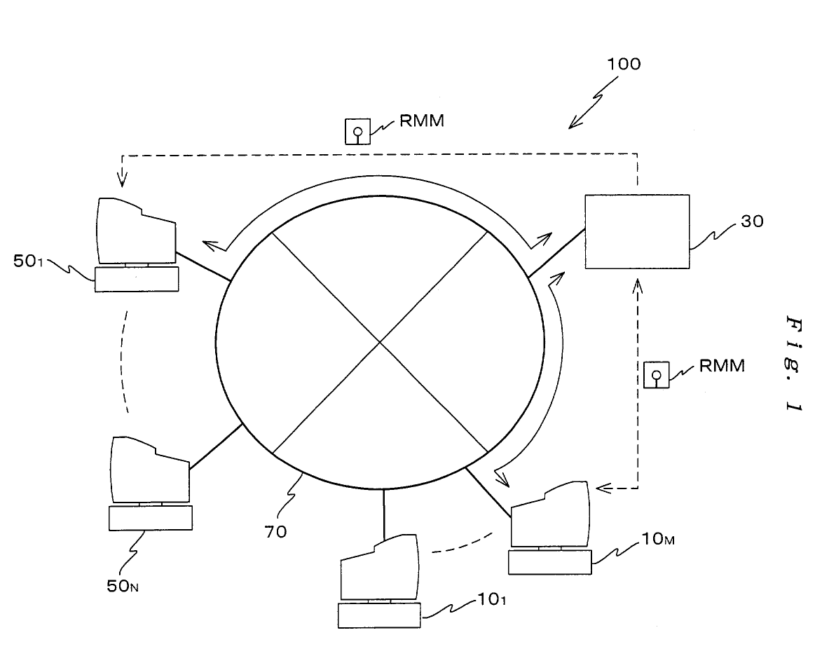

An embodiment of the present invention will be described below with reference to FIGS. 1 to 8.

FIG. 1 shows the schematic view of an image-information-delivery system 100 of the embodiment according to this invention. The image-information-delivery system 100 comprises image-information-creation units 10₁ to 10_{M}, an image-information-delivery unit 30, image-display units 50₁ to 50_{N}, and a network 70.

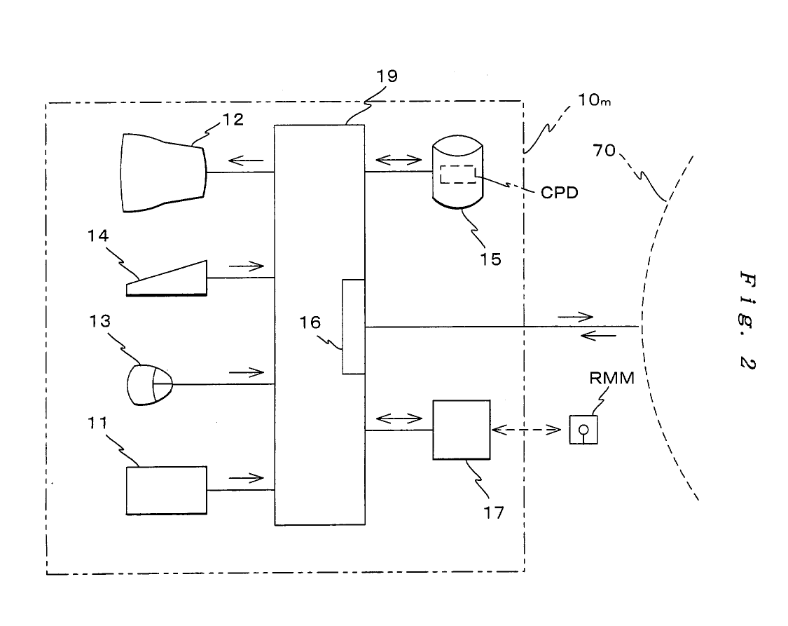

The image-information-creation units 10ₘ (m=1 through M) are units that creators (directors) of display images use. As illustrated in FIG. 2, the image-information-creation units 10ₘ each comprise (a) an image reader 11 for converting into read-in image data, (b) a display unit 12 for displaying an image such as a CRT display and a liquid crystal display, (c) a position-information-input unit 13, which is a pointing device for designating a position on the display screen of the display unit 12 such as a mouse, (d) a information-input unit 14 such as a key-board for inputting text (or letter) information constituted by a text (or letter) string, (e) a storage unit 15 for storing program data such as a creation program CPD described later and image data, (f) a data read/write unit 17 for reading out data from a storage medium RMM such as a flexible disk or a compact disk and writing data into the storage medium RMM, and (g) a processing unit 19 that is connected with those units and that controls the image-information-creation units 10ₘ entirely. Wherein, the processing unit 19 includes a communication control unit 16 for interfacing with the network 70 and can send and receive data to and from the image-information-delivery unit 30 via the network.

Incidentally, as the image-information-creation units 10ₘ (m=1 through M) personal computers on the market can be employed by connecting necessary peripherals thereto.

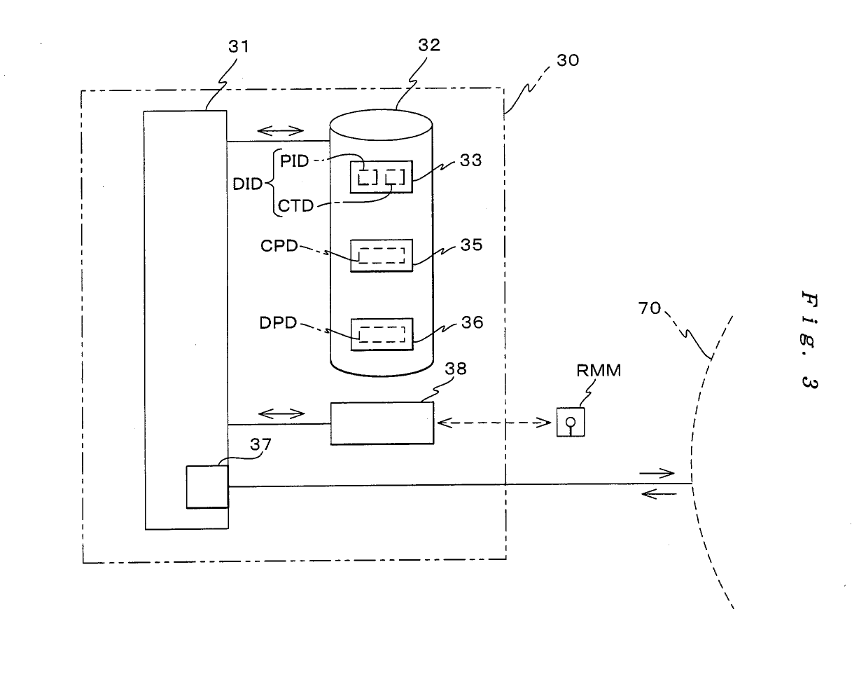

The image-information-delivery unit 30 is managed and used by a system manager of the image-information-delivery system 100, and comprises, as shown in FIG. 3, (a) a storage unit 32 for storing program data, image data, etc., (b) a data read/write unit 38 for reading out data from a storage medium RMM such as a flexible disk or a compact disk and writing data into the storage medium RMM, and (c) a processing unit 31 that is connected with those units and that controls the image-information-delivery unit 30 totally.

The processing unit 31 includes a communication control unit 37 for interfacing with the network 70 and can send and receive data to and from the image-information-creation units 10ₘ or the image-display units 50ₙ via the network 70.

The storage unit 32 has a display-image-information store area 33, a display-image-information creation-control-program (hereinafter, referred to as a “creation-program”) store area 35, and an image-display program (hereinafter, referred to as a “display-program”) store area 36. Here, image data PID, described later, the amount of which is measured in pages and display-image information DID including display-image-control information CTD are stored in the display-image-information store area 33. Furthermore, in the creation-program store area 35 the creation program data CPD for creating the display-image-control information CTD for the image data PID measured in pages is stored, and stored in the display-program store area 36 is display-program data DPD for displaying an image based on the image data PID and the display-image-control information CTD.

Incidentally, as the image-information-delivery unit 30 a workstation or personal computer with necessary peripherals connected thereto can be employed.

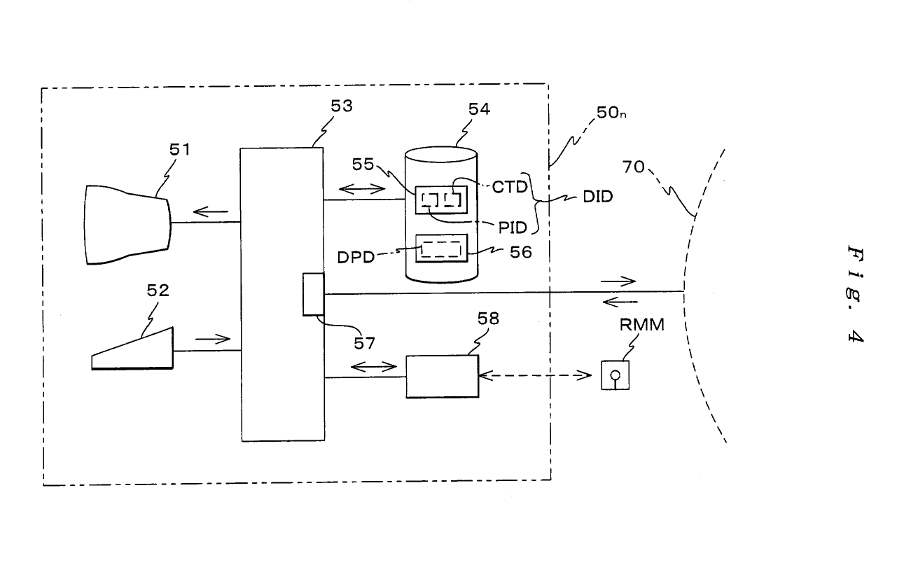

The image-display units 50ₙ (n=1 through N) are units that so-called readers use to enjoy a story and with a feeling as vivid as if they were present there, and each comprise, as shown in FIG. 4, (a) a display unit 51 for displaying an image such as a CRT display or a liquid crystal display, (b) a information-input unit 52 composed of a key-board for inputting character information constituted by a character string, and a mouse for selecting an icon, (c) a storage unit 54 for storing program data, image data, etc., (d) a data read/write unit 58 for reading out data from a storage medium RMM such as a flexible disk or a compact disk and writing data into the storage medium RMM, and (e) a processing unit 53 that is connected with those units and that controls the image-display unit 50ₙ overall.

The processing unit 53 includes a communication control unit 57 for interfacing with the network 70 and can send and receive data to and from the image-information-delivery unit 30 via the network.

Furthermore, the storage unit 54 has a display-image-information store area 55 and a display-program store area 56; display-image information DID is stored in the display-image-information store area 55, and display-program data DPD is stored in the display-program store area 56.

Using the image-information-delivery system 100 having the structure described above, an creator creates a display image, which is delivered to readers in a manner described in the below.

As a premise, it is assumed that creation program data CPD and display-program data DPD are stored in the creation-program store area 35 and the display-program store area 36 of the storage unit 32 of the image-information-delivery unit 30 respectively. Incidentally, creation program and display program that have been developed and created using the image-information-delivery unit 30 may be stored in the creation-program store area 35 and the display-program store area 36, or creation program and display program that have been developed and created using a computer system (not shown) for developing programs may be sent to the image-information-delivery unit 30 via the network 70 or a storage medium RMM.

The manner of an creator creating display-image information using an image-information-creation unit 10ₘ and preparing for the delivery of the display-image information will be described below.

Firstly in creating display-image information, the creator obtains creation program data CPD via the network 70 from the image-information-delivery unit 30 or via a storage medium RMM.

If obtaining the creation program data CPD via the network 70, the creator operates the information-input unit 14 or position-information-input unit 13 of an image-information-creation unit 10ₘ to input a request for the creation program data CPD (hereinafter, referred to as a “request CPQ”), and the processing unit 19 that has received the request CPQ sends the request CPQ to the image-information-delivery unit 30 via the communication control unit 16 and the network 70.

The processing unit 31 of the image-information-delivery unit 30 receives the request CPQ from the image-information-creation unit 10ₘ via the communication control unit 37, confirms that the image-information-creation unit 10ₘ is a terminal of the image-information-delivery system 100 of this embodiment, subsequently, reads out the creation program data CPD from the storage unit 32, and sends the creation program data CPD to the image-information-creation unit 10ₘ via the communication control unit 37 and the network 70.

The processing unit 19 of the image-information-creation unit 10ₘ that has received the creation program data CPD via the communication control unit 16 stores the creation program data CPD in the storage unit 15. Incidentally, in storing the creation program data CPD, the processing unit 19 of the image-information-creation unit 10ₘ needs to install the creation program for execution.

Meanwhile, if the creation program data CPD is obtained via a storage medium RMM, the storage medium RMM is loaded into the data read/write unit 17, which medium RMM contains the creation program data CPD and which is sent from the system manager to read out the creation program data CPD. The processing unit 19, that has had the creation program data CPD inputted thereto in this manner, stores the creation program data CPD in the storage unit 15 in the same way as with the network 70.

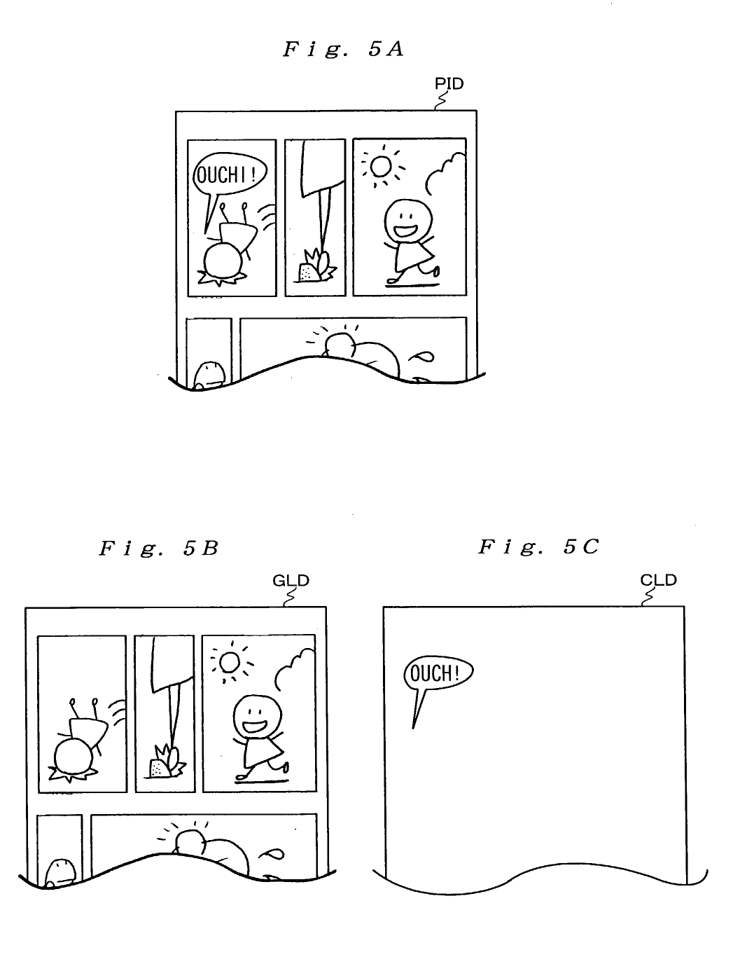

Next, the creator creates page-image data PID constituting the display image data. In this embodiment, when creating the page-image data PID from a display image shown in FIG. 5A, the creator stratifies the page-image data PID into layers one of which is figure-layer data GLD containing only figures as shown in FIG. 5B and the other of which is character-layer data CLD containing only characters as shown in FIG. 5C. Such layers are formed as follows. Firstly, the processing unit 19 reads the illustration as the image data, wherein figures and texts are included and those are drawn by the creator beforehand and, by using the image-reader 11. Then, the area containing characters are separated from the image data to create character-layer data CLD and the rest of the image data is used to create the figure-layer data GLD, and then the formation of the layer is completed. Alternatively, if the image-information-creation unit 10ₘ has a function of creating an image, the creator can create them using the function.

In addition, the dialogs for the characters are displayed by using the text image in balloons. In order to create the text image, the illustration without including the text in the balloon is firstly read by the image reader 11 to create the figure-layer data GLD. Then the text to be inputted through the position-information-input unit 13 or the information-input unit 14 is arranged in the space corresponding to that of the balloon area of figure-layer data GLD, thereby the character-layer data CLD is formed.

Figure-layer data GLD may contain the illustration with neither dialogs nor balloons, and character-layer data CLD may contain the dialogs with balloons.

Moreover, if the image-information-creation unit 10ₘ has a function of creating an image, the creator can create figure-layer data GLD and character-layer data CLD individually using the function.

Furthermore, in order to represent the feeling of the character in the story, the data for title-roll-display may be separately created as character-layer data CLD from the layer to be edited. In this case, when the character layer is composed of plural layers, the dialog in the balloon area described above and the title roll are created as different layer data thereby these layers can be superposed to be displayed.

In addition, when the figure-layer data GLD is composed of plural layers, the current image in the story progresses and previous one is possibly displayed simultaneously. Therefore, the recollection by the current character of the story can be easily displayed. Also, the background color can be easily set, and a plurality of the same images are piled up slantly to be displayed, wherein the images are formed as the different layered data.

That is, the creator creates the page-image data PID having layers, using the image reader 11 or the image-creation function of the image-information-creation unit 10ₘ as needed. It is noted that the page-image data PID may consist of a page or a plurality of pages.

Furthermore, data for sounds is created as a layer of the page-image data PID.

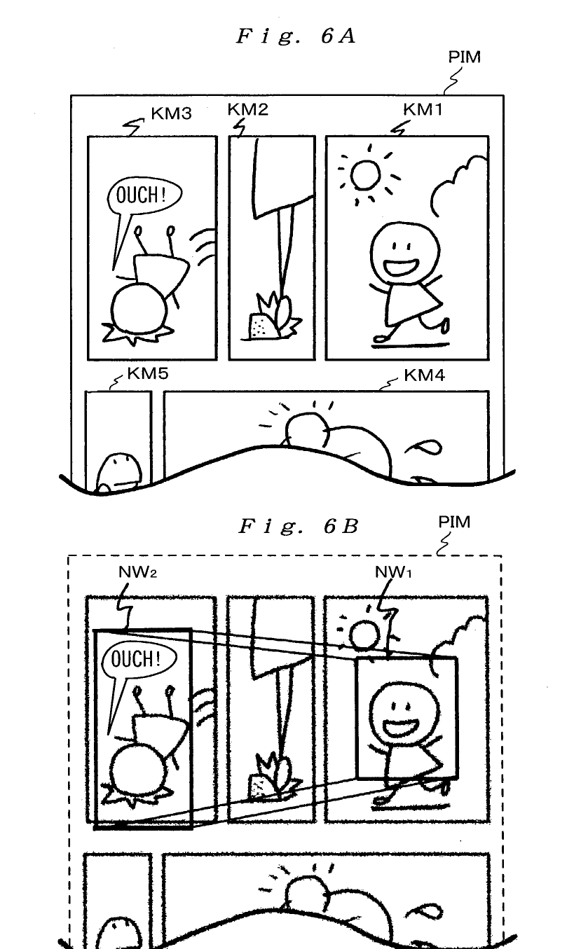

Subsequently, according to an instruction of the creator, the processing unit 19 has the display unit 12 display an image PIM for one page, or part thereof, out of the page-image data PID. In this manner, FIG. 6A shows an example of the image PIM displayed. As shown in FIG. 6A, the image PIM is divided on screen into a plurality of areas (scenes) KM1, KM2, KM3, KM4, KM5, etc., in which the illustrations representing a story progressing in this order are drawn.

Then the creator starts execution of the creation program and specifies the position and shape of an area that the creator wants to show, i.e. a first node area NW₁, in this displayed image (page image), via the position-information-input unit 13. FIG. 6B shows an example of the node area NW₁. Subsequently, the creator operates the information-input unit 14 or the position-information-input unit 13 to specify, for each image-layer, display-options concerning display of the node area NW₁, as needed, in order to produce an desirable effect by the creator to be added to the display image of the node area NW₁. As examples for the display-options, all of which are well-known, there can be mentioned such as a display time period, image-blurring display, cut-in display, zoom display, image rotation, wipe, the paging effect, ripple display, diffusion display, cross-fading display, mosaic, texture display, sound and the like, and anyone is chosen form them optionally.

For example, when specifying image-blurring display only for a figure-layer, the image of the figure-layer shakes on screen while the image of the character-layer does not shake. As a result, the image of the figure-layer is given the visual effect due to image-blurring display without causing the lines in the image of the character-layer hard to read.

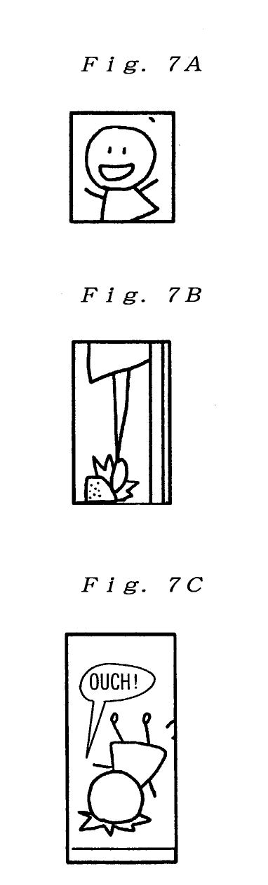

Next, the creator operates the information-input unit 14 and the position-information-input unit 13 to specify the position and shape of a next node area NW₂ that the creator wants readers to watch next in the story progress and to specify a time period T_{1,2} of the display area moving from the node area NW₁ to the node area NW₂. Subsequently, the creator operates the information-input unit 14 or the position-information-input unit 13 to specify display-options for between nodes, as needed, in order to produce an desirable effect by the creator to be added to the display image during the movement from the node area NW₁ to the node area NW₂. As the example of the well-known display-options for between nodes, there can be mentioned such as image-blurring display, fade-in, fade-out, zoom display, image rotation, wipe, ripple display, diffusion display, cross-fading display, stratified-image display, mosaic, texture display, sound effect and the like, and can be optionally chosen from them. As a result, as shown by a display image in the node area NW₁ (FIG. 7A), a display image at a time during the movement (FIG. 7B) and a display image in the node area NW₂ (FIG. 7C), display-control information is created for changing the position and shape of the display area consecutively during movement from the node area NW₁ to the node area NW₂.

Subsequently, the creator operates the information-input unit 14 or the position-information-input unit 13 to specify display-options concerning display of the node area NW₂ as needed in order to produce an desirable effect by the creator to be added to the display image of the node area NW₂. As the example of the display-options, there can be mentioned such as image-blurring display, cut-out display, zoom display, fade-in, fadeout, image rotation, wipe, ripple display, diffusion display, cross-fading display, stratified-image display, mosaic, texture display, sound and the like, can be optionally chosen from them.

After that, the creator operates the information-input unit 14 and the position-information-input unit 13 to specify the position and shape of a next node area NWₖ (k=3 or later) that the creator wants readers to watch next in the story progress and to specify a time period T_{k-1, k} of the display area moving from a node area NWₖ₋₁ to the node area NWₖ and an above display-option for between-nodes as needed.

Moreover, the creator operates the information-input unit 14 or the position-information-input unit 13 to specify display-options concerning display of the node area NWₖ as needed in order to produce an effect that the creator wants to add to the display image of the node area NWₖ. As the example for the display-options, there can be mentioned such as a display time period, image-blurring display, cut-in display, cut-out display, zoom display, fade-in, fade-out, image rotation, wipe, the paging effect, ripple display, diffusion display, cross-fading display, stratified-image display, mosaic, texture display, sound effect and the like, and can be optionally chosen from them. Upon specifying a first node area of each page, cut-in display must be specified. Furthermore, only upon specifying the first node area of each page, the paging effect can be specified.

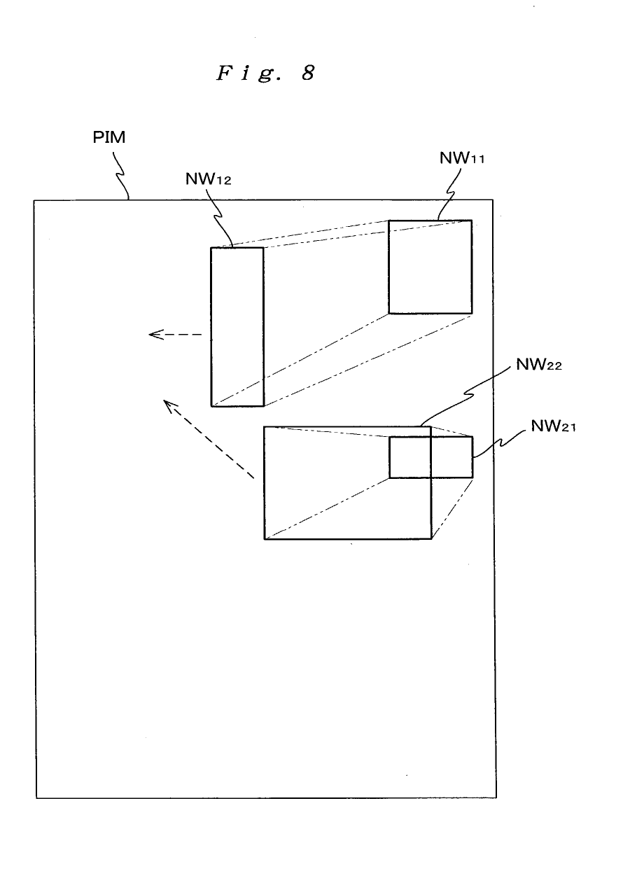

Furthermore, although the above describes the case of specifying node areas with respect to one movement path, as shown in FIG. 8, an image display moving from a node area NW₁₁ via a node area NW₁₂ and an image display moving from a node area NW₂₁ via a node area NW₂₂ can be specified to run in parallel. It is noted that the number of movement paths for node areas displayed at the same time is any number.

As described above, under the control of the creation program, display-image-control information CTD is created in which the positions, shapes and display-option specifications of node areas and movement time periods between node areas are arranged in order of the node areas being displayed. After display-image information DID constituted by the page-image data PID and the display-image-control information CTD are created, the image-information-creation unit 10ₘ sends the display-image information DID to the image-information-delivery unit 30.

The display-image information DID is sent via the network 70 or a storage medium RMM.

If the display-image information DID is sent via the network 70, the processing unit 19 sends the display-image information DID to the image-information-delivery unit 30 via the communication control unit 16 and the network 70. The processing unit 31 of the image-information-delivery unit 30, that has received the display-image information DID from the image-information-creation unit 10ₘ via the communication control unit 37, stores the display-image information DID in the storage unit 32.

Meanwhile, if the display-image information DID is sent via a storage medium RMM, the processing unit 19 writes the display-image information DID into the storage medium RMM using the data read/write unit 17. Then the creator sends the storage medium RMM to the system manager; the storage medium RMM is loaded into the data read/write unit 37 to read out the display-image information DID. In this way, the display-image information DID read out is stored in the display-image-information store area 33 of the storage unit 32.

In the above manner, the creation of the display-image information DID by the creator and it is completed to prepare for delivering the same to readers.

Next, image display based on the display-image information DID will be described.

In image display based on the display-image information DID, first, a reader obtains display program data DPD via the network 70 from the image-information-delivery unit 30 or via a storage medium RMM.

If obtaining the display program data DPD via the network 70, the reader operates the information-input unit 52 of an image-display unit 50ₙ to input a request for the display program data DPD (hereinafter, referred to as a “request DPQ”), and the processing unit 53 that has received the request DPQ sends the request DPQ to the image-information-delivery unit 30 via the communication control unit 57 and the network 70.

The processing unit 31 of the image-information-delivery unit 30 receives the request DPQ from the image-display unit 50ₙ via the communication control unit 37, confirms that the image-display unit 50ₙ is a terminal of the image-information-delivery system 100 of this embodiment, subsequently, reads out the display program data DPD from the storage unit 32, and sends the display program data DPD to the image-display unit 50ₙ via the communication control unit 37 and the network 70.

The processing unit 53 of the image-display unit 50ₙ that has received the display program data DPD via the communication control unit 57 stores the display program data DPD in the storage unit 54. Incidentally, in storing the display program data DPD the processing unit 53 of the image-display unit 50ₙ needs to install the display program for execution. In addition, from the viewpoint of protecting copyrighted products, encrypted data strings are sent via the network in the delivery of the display program data DPD.

Meanwhile, if the display program data DPD is obtained via a storage medium RMM, the storage medium RMM is loaded into the data read/write unit 58, which medium RMM contains the display program data DPD and which is sent from the system manager to read out the display program data DPD. The processing unit 53 that has had the display program data DPD inputted thereto in this manner stores the display program data DPD in the storage unit 54 in the same way as with the network 70.

Next, the reader obtains the display-image information DID via the network 70 from the image-information-delivery unit 30 or via a storage medium RMM, likewise. The manner of obtaining the display-image information DID is the same as that of the display program data DPD, previously described. It is noted that because upon obtaining the display-image information DID a request for it occurs and the display-image information DID contains only data, it is stored in the storage unit 54 without the need for installation thereof. In addition, from the viewpoint of protecting copyrighted products, encrypted data strings are sent via the network in the delivery of the display program data DPD.

Subsequently, the reader operates the information-input unit 52 to specify the start of image display, that is, the start of execution of the display program data DPD, and the processing unit 53 that has received the specification reads out the page-image data PID and the display-image-control information CTD concerning the creator's direction from the storage unit 54 and creates image data for display from the page-image data PID according to the display-image-control information CTD. The processing unit 53 as a display control unit has the display unit 51 display images based on the image data created. That is, the display unit 51 displays images shown in FIGS. 7A to 7C.

Incidentally, since the method of implementation of a display option such as image-blurring display, cut-in display, zoom display, image rotation, wipe, the paging effect, ripple display, diffusion display, cross-fading display, stratified-image display, mosaic, texture display, and sound effect is known to one skilled in the art, a description thereof is skipped.

In this embodiment, the reader can operate the information-input unit 52 to specify one or more additional image-display options during the display unit 51 displaying the images. As the example for the additional image-display options are, there can be mentioned such as static display, restarting of continuous displays, preceding node-display area display, next node-display area display, magnified display, and sound volume adjustment, and can be optionally chosen from them. According to additional image-display options specified as well as the display-image-control information CTD, the processing unit 53 rewinds, fast-forwards or partially emphasizes the images. Therefore, readers can enjoy the product reflecting the creator's intent, e.g., differently each time they read it.

As described above, when readers see the cartoon drawn on the paper media, the readers' eyes move in order intended by the creator. The creator of a page image inputs display-image specifications including specifications of display information containing positions, shapes, and display order of node-display areas in the page image, and selection of layers to be displayed for generating the same shift when displaying the page image. Then the display-image control information is created based on the display-image specification.

According to the embodiment of the present invention, the display-image control information created varies including the modification intended by the creator when the paper media is used.

In addition, since the creator can specify transition time periods between node-display areas and options in image display of node-display areas, the creator can add “stage effects” for display, which are impossible to be added to the paper media.

Furthermore, because images are displayed according to the display-image-control information, images, in an image-display area, in accordance with the creator's direction can be displayed, and thus the page image that the creator intended can be displayed.

Moreover, because page-image data and display-image-control information of given pages are delivered to image-display units via a computer network or storage media, the image-display units can display the page image that the creator intended.

It is noted that although in the above embodiment the shapes of display areas are rectangular, the shapes of display areas can be in any shape, e.g. a circle, a triangle, and the like.

Furthermore, the center of display areas of a series of images may be fixed or moved as needed in the display unit 51.

Although, in the above embodiment, the case of the layered page-image data for one a story is explained as one example. However, the layered page-image data for the plural stories, which progress simultaneously, may be formed as the different layers. For example, the image display data for the particular story is formed as a certain layer data, setting elements to be chosen which corresponding to the key elements in developing of the story. These elements to be chosen have independent stories, and the image display data for them are formed as the different layer data. In this case, the story-choice frame is displayed on screen, when the image-display of the given story has progressed to the predetermined stage. The reader is required to choose the element shown in the story-choice frame, and then the image of the layer corresponding to it may be displayed. As a result, the story made by the creator varies depending on the decision, the choice done by the readers, and the readers can enjoy the various variations of the story one at a time.

Moreover, although in the above embodiment the display program and the display-image information DID are sequentially transferred, they may be transferred to readers at the same time.

Furthermore, although in the above embodiment the display-image information DID constituted by the page-image data and the display-image-control information is provided for readers, image data directly used for display may be provided which data is created from the page-image data and the display-image-control information by the image-information-delivery unit.

Moreover, although the above embodiment describes the case where the display unit 51 is a personal computer system or a computer system equivalent thereto and where the network 70 and the display unit 51 are connected by electrical wires, the display unit may be a mobile phone terminal, and the network and the display unit may be connected by radio, needless to say. This invention can be applied regardless of the kind of network or terminals.

The above embodiment describes the display of a page image of pictures drawn in order of the story progressing such as a comic strip. However, note that text, a picture or an illustration drawn on each sheet of OHP scripts, slides, photographs, etc., which were created for introducing a product or a business plan, can be displayed as a page image in a like manners as described herein.

Also in this case, effective presentation is possible by creating image-display information, to which the modification intended by the presenter is added, using the image-information-creation unit 10 in the same way as in the above embodiment and having the image-display unit 50 display the images directed.

### INDUSTRIAL APPLICABILITY

As described above in detail, the display-image-control-information creation unit of the present invention can create display-image-control information for images reflecting the creator's intent sufficiently, and because of displaying according to the display-image-control information created by the display-image-control-information creation unit of the present invention, the image-display unit of the present invention can display the images reflecting the creator's intent sufficiently. Therefore, effective presentation to readers or an audience is possible.

What is claimed is:

1. A display-image-control-information creation unit which creates display-image-control information with respect to a page image of pictures drawn in boxes for scenes in order of a story progressing by using stratified expression having a plurality of layers, the display-image-control-information creation unit comprising:
a display-image specifying means for inputting display-image specifications including specifications of display information containing positions, shapes, for displaying order of node-display areas in the page image, and for selecting at least one layer of the plurality of layers, the specifications of display information determining how one of a position and shape of an image-display area changes consecutively;
a display-image-control-information creation means for creating the display-image-control information based on the display-image specifications.

2. A display-image-control-information creation unit according to claim 1, wherein the plurality of layers include a figure-display layer and a character-display layer.

3. A display-image-control-information creation unit according to claim 1, wherein the plurality of layers include at least one layer in which pictures drawn according to the progression of a first story are present and at least one layer in which pictures drawn according to the progression of a second story, which is different from the first story, are present.

4. A display-image-control-information creation unit according to claim 3, wherein the plurality of layers further include at least one layer in which pictures drawn according to the progression of a third story, which is different from the first and second stories, are present.

5. A display-image-control-information creation unit according to claim 1, wherein the display-image specifications further include, for each of the plurality of layers, between-nodes-display specifications for transition from the node-display area to a next node-display area.

6. A display-image-control-information creation unit according to claim 5, wherein the between-nodes-display specifications include at least one specification selected from the group consisting of the time of the transition, image-blurring display, fade-in, fade-out, zoom display, image rotation, wipe, the paging effect, ripple display, diffusion display, cross-fading display, mosaic, texture display, and sound.

7. A display-image-control-information creation unit according to claim 1, wherein the display-image specifications further include, for each of the plurality of layers, node-display option specifications of image display for the node-display area.

8. A display-image-control-information creation unit according to claim 7, wherein the node-display option specifications include at least one specification selected from the group consisting of display time, image-blurring display, fade-in, fade-out, cut-in, cut-out, zoom display, image rotation, wipe, the paging effect, ripple display, diffusion display, cross-fading display, mosaic, texture display, and sound.

9. An image-display method for displaying a page image of pictures drawn in boxes for scenes in order of a story progressing, wherein images are displayed according to display-image specifications including specifications of display information containing positions, shapes, and display order of node-display areas in the page image, and selection of at least one layer of the plurality of layers, the specifications of display information determining how one of a position and shape of an image-display area changes consecutively.

10. An image-display method according to claim 9, wherein the plurality of layers include a figure-display layer and a character-display layer.

11. An image-display method according to claim 9, wherein the plurality of layers include layers in each of which pictures drawn according to the progression of a story of a plurality of stories different from each other are present.

12. An image-display unit comprising:
a storage means for storing page-image data of pictures drawn in boxes for scenes in order of a story progressing and display-image-control information created from the page-image data by a display-image-control-information creation unit according to claim 1;
a display-control means for instructing to display images of display areas of the page image based on the display-image-control information read out of the storage means; and
a display means for displaying images according to image-display instructions from the display-control means.

13. An image-display unit according to claim 12, wherein the image-display unit further comprises a display-change-operation means with which to tell the display-control means instructions to change display of the display means according to the display-image-control information.

14. An image-display unit according to claim 13, wherein the instructions to change display include at least one instruction selected from the group consisting of static display, restarting of continuous displays, preceding node-display area display, next node-display area display, magnified display, and sound volume adjustment.

15. A storage medium which can be read by a computer, characterized in that page-image data of pictures drawn in boxes for scenes in order of a story progressing and display-image-control information created from the page-image data by a display-image-control-information creation unit according to one of claims 1 to 8 are stored therein.

16. A computer program for performing steps when executed, the steps comprising:
reading display-image-control information out of a storage means which stores page-image data of pictures drawn in boxes for scenes in order of a story progressing and the display-image-control information created from the page-image data by a display-image-control-information creation unit according to one of claims 1 to 8; and
displaying images of display areas of the page-image data on a display unit based on the display-image-control information read out.
